(19) United States
(12) Patent Application Publication
(10) Pub. No.: US 2014/0108174 A1
(43) Pub. Date: Apr. 17, 2014

(54) Geographic identification of point of sale and tracking of sale

(71) Applicant: NagraID S.A., La Chaux-de-Fonds (CH)

(72) Inventor: Patrick Bernheim, Estavayer-le-Lac (CH)

(21) Appl. No.: 13/650,675

(22) Filed: Oct. 12, 2012

(51) Int. Cl. G06Q 20/20; G06Q 20/40

(52) U.S. Cl. CPC G06Q 20/202; G06Q 20/40
USPC 705/21

(57) ABSTRACT

The present invention relates to a system of geographic identification of the point of sale and of tracking of the sale of a consumer good sold by a merchant. The system comprises a bank payment network (4), a sales terminal (E1) and a first element (B1) of the bank payment network. The first element (B1) is configured (a) to issue an authentication medium (D1) to be sent to the sales terminal (E1), the authentication medium (D1) containing an identification number, the format of which is compatible with that accepted by the bank payment network (4), the identification number being linked to a consumer good; (b) to receive from the sales terminal (E1) via the bank payment network (4) the identification number extracted or captured by the sales terminal (E1) at the time of a sale of a consumer good; and (c) to receive from the bank payment network (4) information relating to the sale in order to identify the geographic location of the point of sale and to authenticate the sales operation corresponding to the identification number received.

### FIELD OF THE INVENTION

The present invention relates to a system of geographic identification of the point of sale and of tracking of the sale of consumer goods, for example of watches, of leather goods and in particular of luxury products sold by distributors and specially authorized dealers. In particular, the invention relates to a system configured to authenticate and geographically identify, with a distribution service administrator, the operations of sale of a consumer good by a merchant. The system according to the invention likewise defines a system of management of sales to final customers, enabling a producer, a trademark holder or a distributor to follow the course of these sales and to determine the stocks remaining in particular at the merchants. The invention also relates to a method for carrying out a geographic identification of activation of the point of sale and to do a tracking of the sale of a consumer good in said system. The present invention also relates to an authentication medium used in said system.

### DESCRIPTION OF THE PRIOR ART

Certain products are produced in large numbers and distributed through numerous merchants in a given country or even at the international level. Ideally, it would be necessary for all the logistical operations in the distribution network to be recorded and traced in order to feed a vast international database. This would allow the manufacturer as well as the distributor to have all sorts of pertinent information and above all to check the sales and the possible attempts at piracy. Currently in a typical case, the one and only operation is the activation of the warranty which is done by the merchant who sells the product, who puts on a document provided for this purpose the date of the sale and his signature and/or a mark with the aid of a stamp. The merchant can keep a written indication of the date of the sale for a numbered product as well as possibly the address of the customer who bought it. The merchant can possibly enter these data in his information sales tracking system of his shop. Currently, in certain simplified cases, the cash register receipt given to the customer serves the purpose of a warranty. Also, there is no specific geographic identification and the tracking of the sale is very imprecise or nonexistent.

The problem with the common procedure stems from the fact that the activation of the warranty is done locally through the seller, who does not necessarily inform the distributor of the products under consideration, or the manufacturer of these products, for example the company that holds the trademark for a given product or that is the user of this trademark, about the sale and the activation of the warranty. The seller could make a report to be transmitted periodically to this distributor or this manufacturer to assist them in the management of the warranty service as well as in the management of the stocks and of the distribution of the products in order to supply the market efficiently and optimally. Such a report can be sent by post, by e-mail or through an Internet site belonging to this distributor or manufacturer. However, this does not easily allow efficient and complete management. The merchants must do a certain amount of work which requires time, technical knowledge and diligence. Automatic and computerized management of a warranty service for various consumer products poses today a real problem. In particular, the distributors or their employees do not always have access to a computer in their shops.

The existence of a “grey market”, of alternative routing of consumer goods and of spare parts, are likewise just as much holes in the distribution networks and represents large sums of lost money for all the players in this network.

### SUMMARY OF THE INVENTION

The present invention has as its object to resolve the above-mentioned problems by proposing a geographic system of identification of the point of sale and of tracking of the sale of a consumer good which is efficient and is easy to use for the merchants who sell these consumer goods. In particular, the present invention has as its object to propose such a system which is operational on the international level and which does not limit the number of merchants able to use it.

To this end, the first aspect of the present invention has as subject matter a system of geographic identification of the point of sale and of tracking of the sale of a consumer good sold by a merchant, the system comprising a bank payment network, a sales terminal and a first element of the bank payment network, wherein the first element is configured
to issue an authentication medium to be sent to the sales terminal, the authentication medium containing an identification number, the format of which is compatible with that accepted by the bank payment network, the identification number being linked to a consumer good;
to receive from the sales terminal via the bank payment network the identification number extracted or captured by the sales terminal at the time of a sale of a consumer good; and
to receive from the bank payment network information relating to the sale in order to identify the geographic location of the point of sale and to authenticate the operation of sale of the consumer good corresponding to the identification number received.

Thus, thanks to the present invention, an efficient and relatively simple system is obtained for identifying the geographic location of the point of sale and for offering a system of sales tracking. The first element can in fact be a single physical element or it can be composed of at least two physical elements. As all the authentication documents are identified, upon being used, and thanks to the data received from the banking network, the pieces of information exchanged make it possible to locate very precisely the exact location of the sale. All these pieces of information ensure the tracking of the sale and make it possible, via the banking network, for these pieces of information to be transmitted to different players in the distribution circuit.

A second aspect of the present invention has as subject matter a method for carrying out a geographic identification of the point of sale and a tracking of the sale of a consumer good sold by a merchant for a system comprising a bank payment network, a sales terminal and a first element of the bank payment network, the method comprising the following steps taken by the first element:
issuing an authentication medium to be sent to the sales terminal, the authentication medium containing an identification number, the format of which is compatible with that accepted by the bank payment network, the identification number being linked to a consumer good;
receiving from the sales terminal via the bank payment network the identification number extracted or captured by the sales terminal at the time of a sale of a consumer good; and
receiving from the bank payment network information relating to the sale for identifying the geographic location of the point of sale and for authenticating the operation of the sale of the consumer good corresponding to the received identification number.

A third aspect of the present invention has as subject matter a method for carrying out a geographic identification of the point of sale and a tracking of the sale of a consumer good sold by a merchant for a system comprising a bank payment network, a sales terminal, a first element connected to the bank payment network and a second element, the method comprising the following steps:
the issuing by a first element of an authentication medium to be sent to the sales terminal, the authentication medium containing an identification number, the format of which is compatible with that accepted by the bank payment network;
the creating by the first or second element of a link between the identification number and a consumer good;
the extracting or capturing by the sales terminal of the identification number at the time of a sale of a consumer good;
the transmitting of this identification number to the first or second element;
the receiving by the first or second element of the bank payment network of information relating to the sale; and
the identifying of the geographic location of the point of sale and the authenticating of the operation of sale of the consumer good corresponding to the received identification number.

The other aspects of the present invention are to be found in the dependent claims.

### BRIEF DESCRIPTION OF THE DRAWINGS

The invention will be well understood from reading the following description, give by way of non-limiting example with reference to the attached drawing representing schematically:

FIG. 1 illustrates diagrammatically the system of geographic identification of the point of sale and of tracking of the sale according to an example of the present invention.

### DETAILED DESCRIPTION OF EMBODIMENTS

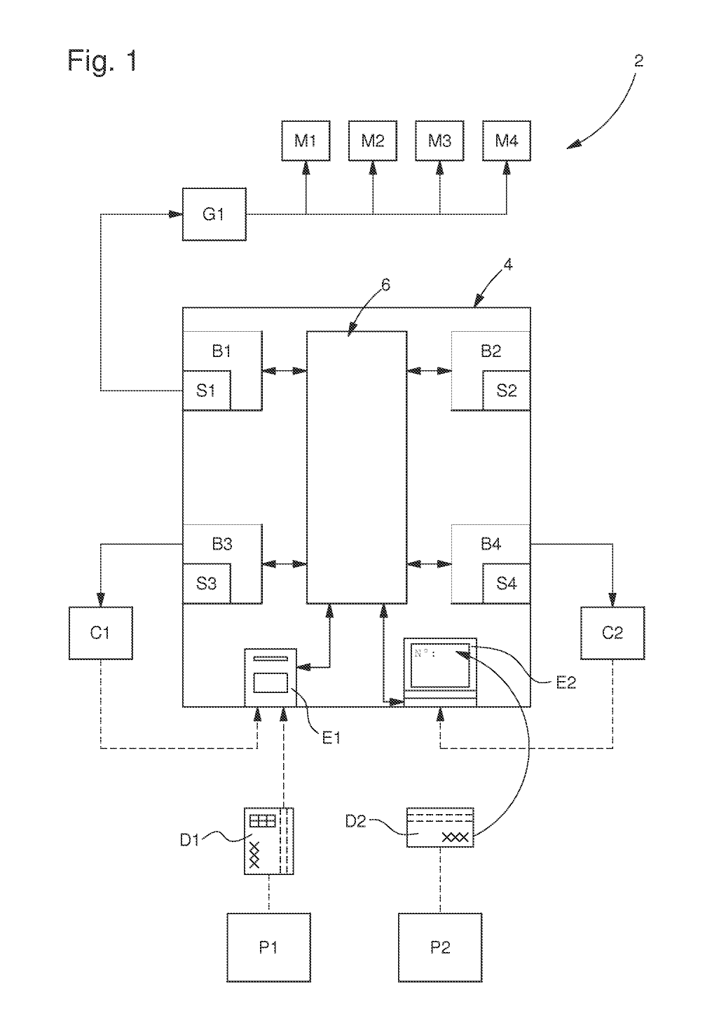

Referring to FIG. 1, one non-limiting embodiment of the system and of the method according to the present invention is now explained in more detail.

In a more detailed fashion, a method for carrying out an identification of the point of sale and for carrying out a tracking of the sale of a consumer good according to a first exemplary embodiment according to the present invention comprises the following steps:

A) Issuance of an authentication medium, which could also be called a guarantee or warranty document, by a first partner of a bank payment network, this authentication medium containing an identification number, the format(s) of which is/are compatible with that or those accepted by the bank payment network;

B) Creation of a link between the created identification numbers and the consumer goods;

C) Transmission of the authentication medium to the merchant who carries out the sale of the consumer good concerned;

D) At the time of the sale of the consumer good, transmission of the identification number to the information processing system of the first partner via the bank payment network, this transmission taking place from a point of entry of this bank payment network to which the merchant has access;

E) Acquisition of the sale data and the identification number by the first partner;

F) Registration, by the information processing system of the first partner, of the fact of receipt of this identification number;

G) Geographic identification of the sale, authentication of the operations of the sale of the consumer good concerned and possibly validation of the warranty for the consumer good concerned;

H) After receipt of the identification number by the first partner, communication, to an administrator of the distribution service for the consumer goods under consideration, of this identification number or of a reference to the consumer good under consideration, possibly with other information concerning the sale;

I) Dispatch of a confirmation to the merchant; and

J) Printing by the merchant of a confirmation.

In a more general way, the collected data are transmitted by a double flux, to the issuer and to the receiver or any other player in the distribution network. Thus added to the geolocation operations is a double flux response. This makes it possible to locate precisely the place of sale with all the details of the sale (date, hour, amount, country, city, etc. . . . ). The sales operation is thus traced and geographically located. Several pieces of information related to this sale are likewise collected and transmitted in order to expand a database. Consequently the system according to the invention also finds application in the monitoring of sales channels in the case of exclusive sales networks notably for luxury or high technology products.

Generally, but not necessarily, the identification number in the authentication medium differs from the product reference used by the manufacturer or the distributor of the product. Therefore a look-up table is provided, which can be created, for example, by the first partner or the administrator, or by another element, allowing the link to be made between the identification number and the product reference. This look-up table can be located with the administrator of the distribution service or introduced directly in the information processing system of the first partner, i.e. the issuer of the authentication documents, in such a way that the administrator or his clients receive directly the product references from the issuer for the corresponding identification numbers that he has received. Thus, at the end of the process, the administrator of the distribution network can receive the data of the tracking of the sale and put them in relation to his internal database, that he will have created from the start, at the time of dispatch of the consumer products. Thus the final connection will have been made between the consumer good and the identification number. All the sales operations are therefore recorded (localization and identification).

Understood by bank payment network is a national or international network installed at the merchants who sell the consumer goods being considered, allowing their customers to carry out bank payment at the time of purchase of these goods. By way of example only, the bank payment network is an international network administered by the companies American Express, MasterCard, or VISA (registered trademarks). This network allows us to channel all the elements of geolocation and of tracking of the sale of the consumer good.

The merchants all take part in a given distribution network, and are very precisely identified. Their connection to the bank payment network makes it possible to locate them geographically. In certain cases the merchant is not identified because he is outside the official distribution network or his area is too large to carry out a simple geolocation. In this particular case, it is proposed according to the invention to then add a supplementary approach to refine the localization. This approach entails the use of a testimony card before the transaction connected with the sale which makes it possible to locate precisely the merchants in the network.

The testimony card is sent to the merchant by the administrator of the distribution network prior to the dispatch of the consumer good. An exchange of information by double flux makes it possible to find out the location with precision and to expand the database. More precisely when the seller is not in an official distribution network, he receives, to begin with, a testimony card, to be used once, that he must use the first time in his electronic payment terminal (EPT). An exchange of information between the two parties (administrator of the network and point of sale) makes it possible to find out with precision the location of the point of sale and to validate the authorized point of sale. This operation is likewise used to locate the different EPTs which are situated in a large area or a multi-storey point of sale. Thus this makes it possible to improve and refine the localization.

In a general way, the geographic identification is made through use of the bank payment network. With each transaction at the electronic payment terminal (which is therefore the point of entry), the data belonging to the device (EPT) and/or to the merchant are sent on the network and are checked by the bank processor. These data are, for example, the code for the country and/or for the city where the transaction has been made, the transaction code, the amount, the hour, etc. It must be understood that the merchant always controls his EPT with his local bank and that, subsequently, the bank processor carries out all the operations of identification and checking. He expands his database using these data. All these data are available on the bank payment network, and make it possible to geolocate the point of sale and to carry out the tracking of the sale.

Understood in a general way by merchant is a shop, any point of sale, a boutique, a stand at a mart or fair, and any entity able to carry out sales of consumer goods. The merchant can be a natural person or a company. In the case of a company, the employees authorized to collect the money from the customers are equated with the merchant. According to the terms used to describe a payment network of the VISA or MasterCard type, the bank of the merchant is called the receiver because it is the one that receives the amount of the sale on a bank account of the merchant via the bank payment network. The merchant can receive in return the data of the tracking of the sale for the party it concerns. Thus a tracking is maintained in the form of confirmation.

Understood by authentication medium is any medium able to be printed on and/or able to be provided with a magnetic strip and/or incorporated into an electronic unit, such as a chip, linked to communication means. These communication means can be resistive or contactless, for example an antenna. This medium can be a sheet of paper, a plastic card, a product package or the product itself. The plastic card is, for example, an electronic card of common banking format. In particular in the case of a medium incorporating an electronic unit, managing the geographic identification application and the application of authentication of the sales operations, and in which the identification number is recorded, and an antenna or an emitter connected with this electronic unit in order to communicate with a contactless electronic payment terminal (equipped with RF or infrared communication means, for example), the authentication medium can be a paper document, an electronic label or an electronic card or plate of any form or any other object of transponder type. This medium can also be a portable telephone or another electronic device of the merchant equipped with communication means for receiving from an administrator of a distribution service or from companies using the trademarks for the products concerned the identification numbers of these products that are provided to the merchant. This portable telephone or other electronic device is preferably equipped with means of communication with an EPT. In a special embodiment, the authentication medium consists of a single magnetic strip disposed on the consumer good or its packaging. In another special embodiment, the authentication medium consists only of an electronic unit and its communication device, notably an antenna, and it is incorporated in the product itself or in its packaging, the product or its packaging serving then as medium.

Understood by point of entry in the bank payment network is preferably an electronic payment terminal of this network installed at a point of sale of the merchant. In another variant, the point of entry in the payment network can consist of an Internet site giving access to this network via a secured interface in which at least the identification number of the good sold is entered in the same way as a VISA or MasterCard card number, but in order to identify and authenticate this good. It will be noted that any point of entry accepted by the bank payment network can be used.

Understood by partner of the bank payment network is notably the banks and other financial organizations that administrate bank accounts and which are members or partners of this network. The partner of the bank payment network who issues the identification numbers of the consumer goods under consideration, these identification numbers having a format compatible with this network, is also called the issuer.

In the case of a bank payment network, the issuer generally issues bank cards containing a card number in the format of the network for making bank transactions. The card is generally issued in the name of a natural person or legal entity (the client of the issuer) who is called the bearer because he or she possesses the card and disposes of it. At the time of a payment, the buyer generally carries the bank card on him. Within the framework of the present invention, the client of the issuer is the administrator of the distribution service. This administrator of the distribution service is not a bearer of the bank card in the sense of the conventional payment network. In fact, it is possible in certain cases that this administrator never has the issued authentication medium or more generally the issued authentication medium with the identification number. The bearer changes in the course of time following the issue of the authentication medium up until the sale of the related product. Initially, the authentication media can be issued to the administrator of the distribution service or directly to a production unit for the product concerned or also, for example, to a company that makes the packaging for the product or that carries out the distribution. Then the authentication medium follows the product until it is with the merchant who then becomes the custodian of this authentication medium until the sale of the product. After the sale, the authentication medium generally returns to the customer of the merchant having acquired the product, after the identification and the authentication have been carried out through this merchant according to the invention.

Understood very broadly by administrator of the distribution service is an entity, a company, an organization entrusted in particular by a production or distribution company for the products under consideration with having the authentication media issued at an issuer of the bank payment network foreseen. This administrator has an account with this issuer who links the issued authentication media to this account. Consequently, each authentication medium can have an account linked to it. It is to the distribution service administrator that the issuer provides the data that he receives or that he processes in relation to these authentication media, according to different variants of the invention. These data can also be provided directly to other entities authorized by the distribution service administrator or can be provided by the latter to these other entities, notably after having processed these data in order to present them in a predefined form. The other entities are in particular the companies or their subsidiaries that hold or use the trademarks of the products, the producers, or distribution companies for these trademarks, etc. It is to be noted that the distribution service administrator can also be itself a company that holds or manages the trademark of the products, particularly a watchmaking enterprise manufacturing watches and selling them to distributors and/or merchants carrying out the sale to final customers. This term is therefore very broad and is not at all limiting; it refers to the client of the issuer. According to a variant of the present invention, the administrator of the distribution service receives in return the precise location of the sale with tracking elements for the sale of the consumer good, such as the date, the hour, the amount, the country, the city, etc. In this way he can expand his internal database and make a comparison with his initial file. Thus the traceability is complete, and he completely controls the entire distribution loop.

A concrete case according to an embodiment of the present invention will be described in the following, in particular with the aid of FIG. 1, given by way of absolutely non-limiting example, which figure represents diagrammatically a bank payment network according to the invention for the geographic identification and the authentication of the operations of sale of consumer goods.

Represented in this FIG. 1 is a system 2 for geographic identification and for tracking of the sale of consumer goods or products P1 and P2. The consumer goods are sold by merchants C1 and C2, the number of merchants not being limited. This identification system is made up of a bank payment network 4 and each of the products P1, P2 is linked to an authentication medium D1, respectively D2, in which an identification number (XXX) is written or recorded, the format (s) of which is/are compatible with that or those accepted by said bank payment network. The authentication medium consists in this example of an electronic card. The card D1 has an electronic unit whereas the card D2 has only a magnetic strip.

The geographic identification and the authentication of the operations of sale of any one of the products can be carried out from a point of entry E1 or E2 of the bank payment network to which the merchant C1, respectively C2, who sells the consumer good under consideration, has access. In the embodiment represented in FIG. 1, the point of access E1 consists of an EPT and the point of access D2 is made up of the secured interface of a website displayed by a computer, this website belonging to network 4 and being connected to system 6 for processing and communication of data relating to the transactions carried out by the bank payment network. It will be noted that the secured interface can, in a variant, be directly connected to system 6 without passing through the web network or Internet. The EPT E1 is configured to read the identification number in banking format recorded in the electronic unit of the electronic card D1. In a variant not shown, the access point E1 is configured to read the magnetic strip of the card D1. For the access point E2, it is necessary to enter the identification number XXX on the page of the secured interface provided for this purpose. Therefore this number is written on the card D2. Other types of entry points can be foreseen, in particular a server or a telephone service of the network 4 which is accessible through a call line, in particular by means of a portable telephone, and to which the necessary data are transmitted for a request for authorization to debit a bank account of the administrator G1 of the distribution service at the issuer of the authentication medium in favor of a bank account of the merchant who makes the sale.

At the time of geographic identification and authentication of the sales operations, the bank payment network 4 is configured to transmit, from the point of entry E1 or E2, at least the identification number XXX of the product P1 or P2 to the information processing system S1 of a first partner of this network 4, the bank B1, which has issued this identification number for an administrator G1 of the distribution service for the consumer goods concerned. The information processing system S1 of this first partner records the fact that an identification number has been transmitted to him. The information processing system S1 of a first partner also receives from the bank payment network 4 the data (the date, the hour, the amount, the country, and/or the city, etc.) concerning the sale. These data can be received at the same time as the identification number.

In the example of FIG. 1, the administrator G1 is a company authorized by various companies owning trademarks M1, M2, M3 and M4. The administrator 1 has an account with the bank B1 which is specific to the processing of the geographic identification and authentication of the sales operations according to different embodiments and various variants which will be explained in the following. After the reading of the card, the administrator G1 receives from the issuer at least the identification numbers relating to the authentication media activated in relation to this account or he receives the references for the consumer goods corresponding to these identification numbers. In a special variant, the convenience of which will be seen in the following, the account of the administrator is a bank account.

Thus the information processing system of the first partner B1 communicates to the administrator G1 of the distribution service the identification numbers received or, for a received identification number, a reference (for example model reference, serial number or number of the piece) for the consumer good corresponding to this identification number. In fact, generally, the identification number of the authentication medium suitable for the geographic identification and the authentication of the sales operations is different from the product reference used by the manufacturer or the distributor of the product. Therefore a look-up table is provided allowing the link to be made between the identification number for the identification via the network 4 and the product reference. This look-up table can be located at the administrator of the distribution service or introduced directly into the information processing system by the first partner, i.e. the issuer of the authentication media, in such a way that the administrator or his clients receive directly the product references from the issuer for the corresponding identification numbers that he has received.

FIG. 1 mentions still another partner B2, having his own information processing system S2, which can act as an issuer for another administrator and/or as a buyer for another merchant.

According to this example, the transmission of the identification number by the bank payment network 4 is carried out via a request for authorization at the first partner B1 of this network, to debit a given amount to a first bank account (belonging to the administrator G1 of the distribution service) linked to the identification number in question. This given amount can be a symbolic amount, but in any case this amount is not the payment for the consumer good concerned. According to this example, this amount is defined by the banking processor (not shown in FIG. 1). It is to be noted that the authentication medium is not able to be used for paying for the consumer good concerned.

According to a first variant of the main embodiment, the information processing system S1 of the first partner of the bank payment network, following the request for authorization, refuses the debit of the given amount and records the fact of this request for authorization for the identification number received which it considers as the authentication of the sales operations for the consumer good to which this identification number is linked.

According to a second variant of the main embodiment, the merchant C1 or C2 who carries out the sale of the consumer good under consideration P1, respectively P2, has a second bank account with a second partner B3, respectively B4, of the bank payment network 4. Following the request for authorization and in the case where the geographic identification and the authentication of the operations of sale of the good under consideration is accepted, the information processing system S1 of the first partner authorizes the debit of said given amount from the first bank account in favor of the second bank account.

In a particular case of this second variant, a debit authorization is granted by the information processing system S1 of the first partner B1 only for an amount less than or equal to a predetermined maximum amount.

In another special case, the debit authorization is granted by the information processing system S1 of the first partner only for a predefined amount.

Preferably, an authorization to debit the first account for an identification number is given only once, after which this identification number is deactivated in the information processing system of the first partner for that which concerns the banking transactions.

According to an alternative, the authentication medium comprises an electronic unit managing the payment application, this electronic unit being configured to allow one single banking transaction via an EPT, after which said payment application is deactivated in the electronic unit and the authentication medium is no longer accepted by the bank payment network for making a payment. The deactivation of the payment application can be carried out in diverse ways, either by an instruction received from the first partner via the EPT, or by the EPT itself at the time when a banking transaction has been accepted with the authentication medium, or moreover by the electronic unit itself which, on the basis of the standard communication with the EPT, detects an accepted banking transaction.

In a general way, in the case where the geographic identification and the authentication of the operations of sale of the good under consideration have been accepted, in a variant it is foreseen that the first partner B1 confirms these actions through a specific message sent to the point of entry.

Thus, according to an improved embodiment of the first or of the second above-mentioned variant, together with its response to the request for authorization and in the case where the geographic identification and the authentication of the operations of sale of the good concerned is accepted, the first partner B1 confirms the operations through a specific message sent to the point of entry to the network.

According to one possibility, the point of entry is connected to a printing unit configured to print a receipt of the confirmation of the geographic identification and the authentication of the sales operations. The response by double flux is thus activated.

According to a general variant, an identifier of the merchant is likewise transmitted to the information processing system S1 of the first partner B1 together with or without the transmission of an identification number by this merchant. Consequently, the information processing system S1 of the first partner B1 can verify whether the merchant is authorized to carry out the sale of the consumer good concerned.

In a variant, the geographic identification and the authentication of the operations of sale of the consumer good concerned is activated only if the merchant is authorized.

In another variant, in the case where the merchant is not authorized to carry out the sale of the consumer good concerned, the information processing system S1 of the first partner B1 records the receipt of the identification number and communicates this fact to the administrator G1 of the distribution service.

In another variant, in the case where the merchant is not authorized to carry out the sale of the consumer good under consideration, the information processing system S1 of the first partner B1 indicates this to the point of entry.

According to a general variant, the information processing system S1 of the first partner B1 verifies whether the geographic identification and/or the authentication of the operations of sale of the consumer good linked to the identification number has been prohibited. In particular, in the case where the geographic identification and/or the authentication of the operations of sale of the consumer good under consideration has been prohibited, the information processing system S1 of the first partner indicates this to the point of entry.

According to a specific variant, in the case where the geographic identification and the authentication of the operations of sale of the consumer good under consideration has been prohibited, the information processing system S1 of the first partner communicates to the administrator G1 of the distribution service the receipt of the identification number for this consumer good.

The authentication medium can be provided with an expiration date for the geographic identification and the authentication of the sales operations, in particular for the products which call for maintenance such as a mechanical watch. In the case of an electronic document, the expiration date can be recorded in the authentication medium, and the electronic payment terminal verifies that this date has not passed before initiating a banking transaction or, in a general way, initiating the geographic identification and the authentication of the sales operations. It will be noted that this expiration date can also be recorded in the information processing system of the issuer who does not agree to carry out a banking transaction or, in a general way, the geographic identification and the authentication of the sales operations if this expiration date has passed. In this case, the merchant must, for example, return the product for a check or a maintenance service, and he will receive a new authentication medium, or the expiration date will be reprogrammed in the electronic authentication medium.

According to another general variant, no information connected to the administrator G1 of the distribution service can be learned from the identification number linked to an authentication medium or from other data circulating in the bank payment network in relation to the geographic identification and the authentication of the operations of sale of the corresponding good, the identity of this administrator being known only from the first partner B1 in this system.

According to one example, the authentication medium is made up of a card of banking type D1 or D2. The point of entry to the bank payment network is here an EPT installed at the merchant and adapted to read the magnetic strip or the electronic unit of the card.

The authentication medium used in the method of the invention, in particular a card D1, D2, contains an identification number XXX having a format or formats compatible with that or those accepted by a bank payment network 4. According to the invention, this authentication medium is issued by a partner (issuer) of the bank payment network.

As concerns the authentication medium, the identification number can be recorded on a magnetic strip or in an electronic unit of this authentication medium, this electronic strip or this electronic unit being configured in such a way as to allow electronic payment terminals of the bank payment network to be able to read at least this identification number.

Several variations in the configuration explained above can also be envisaged without going beyond the scope of the present invention. For example, the system described above could be used to activate a warranty for the consumer good concerned. This warranty could be activated by the first partner B1 or by the administrator G1 after having received the identification number from the EPT and after having consulted the look-up table. Then a confirmation could be sent to the point of entry.

Also the first partner B1 could encompass the administrator G1 to form a single physical element.

1. A system of geographic identification of the point of sale and of tracking of the sale of a consumer good by a merchant, the system comprising a bank payment network, a sales terminal and a first element of the bank payment network, wherein the first element is configured
to issue an authentication medium to be sent to the sales terminal, the authentication medium containing an identification number, the format of which is compatible with that accepted by the bank payment network, the identification number being linked to a consumer good;
to receive from the sales terminal via the bank payment network the identification number extracted or captured by the sales terminal at the time of a sale of a consumer good; and
to receive from the bank payment network information relating to the sale in order to identify the geographic location of the point of sale and to authenticate the operation of sale of the consumer good corresponding to the identification number received.

2. The system according to claim 1, wherein the system further comprises a second element, and the first element is configured to communicate to the second element at least one of the following pieces of information:
the identification number received or, for the received identification number, a reference to the corresponding consumer good for this identification number, and
at least one part of the information received relating to the sale.

3. The system according to claim 1, wherein the said identification number is received via a request for authorization, at the first element, to debit a given amount from a first bank account linked to the said identification number.

4. The system according to claim 3, wherein the first element is furthermore configured, following the said authorization request, to refuse the debit of the given amount and is configured to register the fact of this request for authorization for said identification number used for the geographic identification and the authentication of the operations of sale of the consumer good to which this identification number is linked.

5. The system according to claim 3, wherein the merchant who carried out the sale of the consumer good concerned has a second bank account with a second partner of the bank payment network, and wherein the first element is furthermore configured, following said request for authorization and in the case where the geographic identification and the authentication of operations of sale of the good under consideration is accepted, to authorize the debit of the given amount from the first bank account in favor of the second bank account.

6. The system according to claim 3, wherein the authorization of the debit is granted by the first element only for an amount less than or equal to a predetermined maximum amount.

7. The system according to claim 3, wherein the authorization to debit the first account for the identification number is given just once, following which this identification number is configured to be deactivated in the first element for that which concerns the banking transactions.

8. The system according to claim 3, wherein the authentication medium comprises an electronic unit managing the payment application, this electronic unit being configured to allow a single banking transaction via an electronic payment terminal, following which said payment application is configured to be deactivated in this electronic unit and the authentication medium is no longer accepted by the bank payment network for carrying out a payment.

9. The system according to claim 1, wherein the first element is furthermore configured to activate the warranty for the consumer good linked to the identification number after having received the identification number.

10. The system according to claim 1, wherein, after having identified the geographic location of the point of sale and having authenticated the sales operation, the first element is furthermore configured to send a confirmation of the identification and the authentication to the sales terminal or to another element directly or indirectly connected to the bank payment network.

11. The system according to claim 10, wherein the sales terminal is connected to a printing unit configured to print the confirmation of the geographic identification and the authentication of the sales operations.

12. The system according to claim 1, wherein the information relating to the sale comprises at least one of the following elements: the date of the sale, the hour of the sale; the amount debited for the sale; the country where the sale was made; the city where the sale was made; the geographic coordinates where the sale was made; the identifier of the merchant; the payment code; and the identifier of the sales terminal.

13. The system according to claim 1, wherein the first element is furthermore configured to receive an identifier of the merchant and to verify whether the merchant is authorized to carry out the sale of the consumer good concerned.

14. The system according to claim 1, wherein the authentication medium is a card of banking type having a magnetic strip in which the identification number is recorded and/or having an electronic unit in which the identification number is recorded.

15. The system according to claim 2, wherein no information connected with the second element can be learned from the identification number or from other data circulating in the bank payment network in relation to the request for the certification of origin, the identity of the verification element being known only from the first element.

16. A method for carrying out a geographic identification of the point of sale and a tracking of the sale of a consumer good sold by a merchant for a system comprising a bank payment network, a sales terminal and a first element of the bank payment network, the method comprising the following steps taken by the first element:
issuing an authentication medium to be sent to the sales terminal, the authentication medium containing an identification number, the format of which is compatible with that accepted by the bank payment network, the identification number being linked to a consumer good;
receiving from the sales terminal via the bank payment network the identification number extracted or captured by the sales terminal at the time of a sale of a consumer good; and
receiving from the bank payment network information relating to the sale for identifying the geographic location of the point of sale and for authenticating the operation of the sale of the consumer good corresponding to the received identification number.

17. A method for carrying out a geographic identification of the point of sale and a tracking of the sale of a consumer good sold by a merchant for a system comprising a bank payment network, a sales terminal, a first element connected to the bank payment network and a second element, the method comprising the following steps:
the issuing by a first element of an authentication medium to be sent to the sales terminal, the authentication medium containing an identification number, the format of which is compatible with that accepted by the bank payment network;
the creating by the first or second element of a link between the identification number and a consumer good;
the extracting or capturing by the sales terminal of the identification number at the time of a sale of a consumer good;
the transmitting of this identification number to the first or second element;
the receiving by the first or second element of the bank payment network of information relating to the sale; and
the identifying of the geographic location of the point of sale and the authenticating of the operation of sale of the consumer good corresponding to the received identification number.
